(19) United States
(12) Patent Application Publication
(10) Pub. No.: US 2006/0130981 A1
(43) Pub. Date: Jun. 22, 2006

(54) Multiple tier venetian blind

(75) Inventor: Tony Marzilli, Mississauga (CA)

Correspondence Address: BERESKIN AND PARR, 40 KING STREET WEST, BOX 401, TORONTO, ON, M5H 3Y2, CA

(73) Assignee: Tribute Window Coverings Inc., Mississauga (CA)

(21) Appl. No.: 11/017,928

(22) Filed: Dec. 22, 2004

(51) Int. Cl. E06B 3/48

(52) U.S. Cl. 160/115

(57) ABSTRACT

A multi-tier venetian blind is disclosed. The venetian blind includes first and second spaced apart ladders suspended from a header rail. The ladders support a number of slats which include an upper tier and a lower tier. The blind also includes lift cords and adjustment cords. The lift cords are connected to a bottom slat and are used lift and lower the slats. The adjustment cords are connected the ladders at a predetermined point and tilt the slats in the lower tier independently of those in the upper tier by moving the ladders at the predetermined point.

### FIELD OF THE INVENTION

This invention relates to window coverings, and in particular to a multi-tier venetian blind.

### BACKGROUND OF THE INVENTION

Venetian blinds are well known. Such blinds consist of a plurality of horizontal parallel slats supported on cord ladders. The ladders are suspended from a header rail mounted to the top of the window. A bottom rail is connected to the bottom ends of the ladders. A tilt control mechanism is typically provided in the header rail to tilt the slats to control the amount of light entering the room. Lift cords typically run from the bottom slat to a cord lock located in the header rail. The lift control mechanism permits the lifting or lowering of the bottom rail to control the portion of the window covered by the blind.

One of the problems encountered with prior art venetian blinds, particularly when installed in large windows, is that users want to control the amount of light entering the room through different sections of the window without lifting or lowering the blind. For example, it is often desirable to tilt the slats in the upper portion of a window to permit light to enter the room, while tilting the slats to a closed position in the bottom portion of the window for privacy reasons (i.e. to prevent people from looking into the building through the window.

Consequently, a number of two-tier venetian blinds have been developed in the prior art. Such blinds permit top and bottom sections or tiers of the slats to be tilted independently of each other. However, such prior art blinds are difficult to install, and are prohibitively expensive to manufacture. Accordingly, there is a need for an improved multiple tier venetian blind which is less expensive and can be manufactured from existing commercially available materials used for conventional single tier blinds.

### SUMMARY OF THE INVENTION

According to a first aspect of the invention, a multi-tier venetian blind is provided. The venetian blind comprises first and second spaced apart ladders operatively suspended from a header rail. The ladders support a plurality of slats which comprise a first tier and a second tier below the first tier. The blind also comprises at least one lift cord and at least one adjustment cord. The lift cord is connected to a bottom slat and adapted to lift and lower the slats. The adjustment cord is connected to the first ladder at a predetermined point and is adapted to tilt the slats in the second tier by moving the first ladder at the predetermined point.

Preferably, the adjustment cord is connected to a loop located on the predetermined point of the first ladder.

According to a second aspect of the invention, a cord lock for controlling a first cord and a second cord is provided. The cord lock comprises:

a) a housing defining at least one pathway therein, the pathway comprising a first portion, a second portion and a third portion;

b) a retaining surface located in the housing; and

c) a first member and a second member slidably received in the pathway;

wherein the first member is movable between the first portion where the first cord moves freely and the second portion where the first member and the retaining surface cooperate to resist movement of the first cord;

wherein the second member is movable between the first portion where the second cord moves freely and the third portion where the first second and the retaining surface cooperate to resist movement of the second cord.

Preferably, the first and second cords are lift cords and adjustment cords, respectively, for a venetian blind.

### BRIEF DESCRIPTION OF THE DRAWINGS

In the accompanying drawings:

FIG. 1 is a rear perspective view of a first embodiment of the multi-tier venetian blind according to the present invention;

FIG. 2 is a cut away perspective view showing the detail of a header rail of the first embodiment;

FIG. 3A is a partial elevation view of the first embodiment in the open position;

FIG. 3B is a partial elevation view of the first embodiment showing a lower tier of the blind in the closed position;

FIG. 4 is a perspective view of a cord lock according to a first embodiment of the present invention;

FIG. 5 a rear perspective view of a second embodiment of the multi-tier venetian blind according to the present invention; and

FIG. 6 is a cut away perspective view showing the detail of a header rail of the second embodiment.

### DETAILED DESCRIPTION OF THE INVENTION

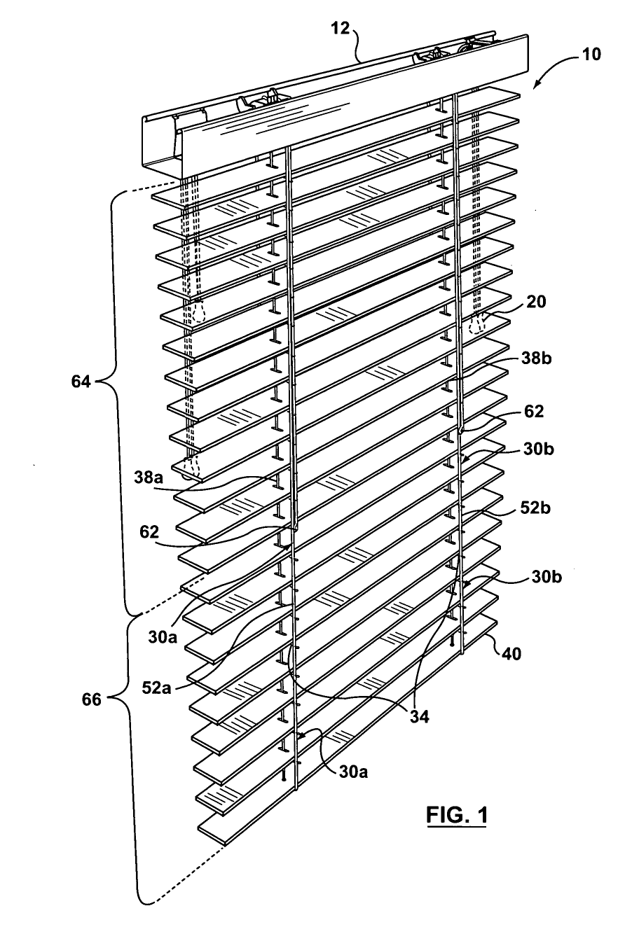

FIGS. 1, 2, and 3A-B show a two tier venetian blind 10 according to a preferred embodiment of the present invention. The blind 10 includes a header rail 12. A conventional tilt mechanism 14 is mounted in the header rail 12. The tilt mechanism 14 includes two cam members 16a, 16b mounted on a tilt rod 18 received longitudinally in the header rail 12. A tilt control cord 20 is connected to the tilt rod 18 by one or more conventional gears 22. It will be understood that a wand (not shown) may be used instead of the tilt control cord 20.

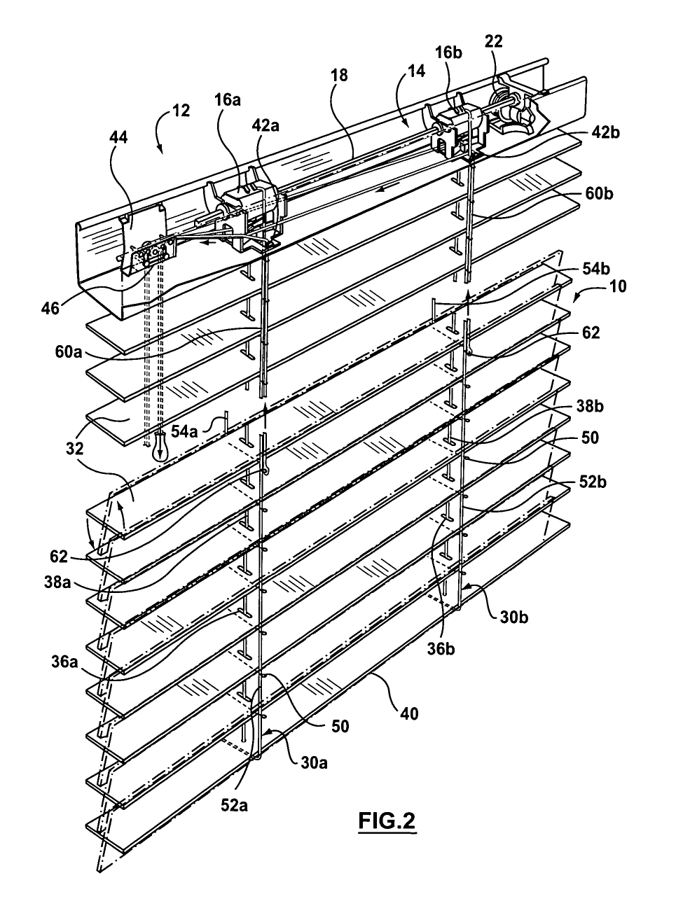

Continuing to refer to FIGS. 1 and 2, a first ladder 30a and a second ladder 30b are suspended from cam members 16a and 16b, respectively. It will be understood that any suitable numbers of ladders and cam members may be provided depending on the size of the blind required. A plurality of slats 32 are supported by the ladders 30a, 30b. The slats may be any suitable width (such as 1″ or 2″ slats), shape (such as rectangular cross-section or “airplane wing” cross-section), or material (such as plastic, wood, aluminum, or the like).

The slats 32 rest on corresponding rungs 34 of each ladder 30a, 30b. Each slat 34 may include a pair of slots 36a, 36b. First and second lift cords 38a, 38b are secured to a heavier bottom slat 40 and run through the slots 36a, 36b of each slat 34. The lift cords pass into the header rail 12 through first openings 42a, 42b. The lift cords 38a, 38b pass through a cord lock 44 (described in detail below) and exit the header rail 12 through a second opening 46, where they are tied together to be controlled by the user.

A plurality of loops 50 are provided along the rear cords 52a, 52b of ladders 30a, 30b, respectively. As used herein, “rear” means the side of the blind 10 facing the window and “front” means the side of the blind facing the room. Preferably the ladders 30a, 30b are cord ladders and the loops 50 are cord loops attached to the ladders in any suitable fashion.

The loops 50 are preferably provided adjacent to each rung 34 of ladders 30a, 30b. It will be understood by those skilled in the art that loops 50 may be provided along front cords 54a, 54b of ladders 30a, 30b. Alternatively, no loops may be provided.

First and second adjustment cords 60a and 60b are each connected to a predetermined point 62 on the rear cords 52a, 52b of ladders 30a, 30b. The predetermined point 62 may be selected by the manufacturer and is located between a first upper tier 64 and a second lower tier 66 of the slats 32. Preferably, the adjustment cords 60a, 60b are tied to corresponding loops at the predetermined point 62, but may be connected to ladders 30a, 30b in any other suitable fashion. The corresponding loops are adjacent to the rungs 34 which support the uppermost slat 34 of the lower tier 66.

The adjustment cords 60a, 60b preferably run through all of the loops 50 of rear cords 52a, 52b above the predetermined point 62 and enter the header rail 12 through first openings 42a, 42b. The adjustment cords 60a, 60b pass through a cord lock 44 (described in detail below) and exit the header rail 12 through the second opening 46, where they are tied together to be controlled by the user.

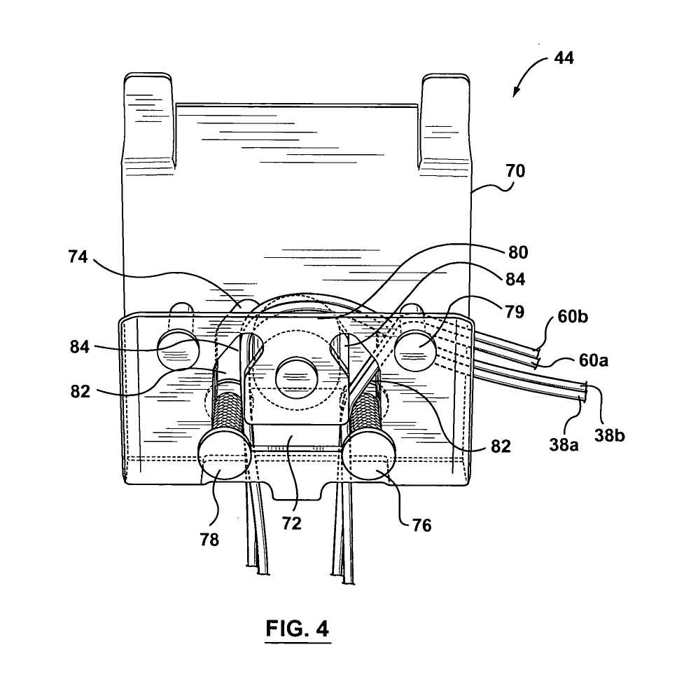

Referring to FIG. 4, the cord lock 44 includes a conventional housing 70 which snaps into the header rail 12 (shown in FIG. 2). A front pathway 72 and opposing rear pathway 74 are defined in the housing 70. First and second members, such as knurled rivets 76, 78 are located in the pathways 72, 74 and are free to slide in the pathways.

Continuing to refer to FIG. 4, adjustment cords 60a, 60b run along the head rail 12, pass over a guide rivet 79, and run between first knurled rivet 76 and curved retaining surface 80 before exiting the cord lock 44. Lift cords 38a, 38b pass under the guide rivet 79 and run between the second knurled rivet 78 and the retaining surface 80. The pathways 72, 74 include substantially vertical portions 82 where the cords slide freely between knurled rivets 76, 78 and retaining surface 80, and angled portions 84 where the cords are prevented from sliding between rivets 76, 78 and retaining surface 80.

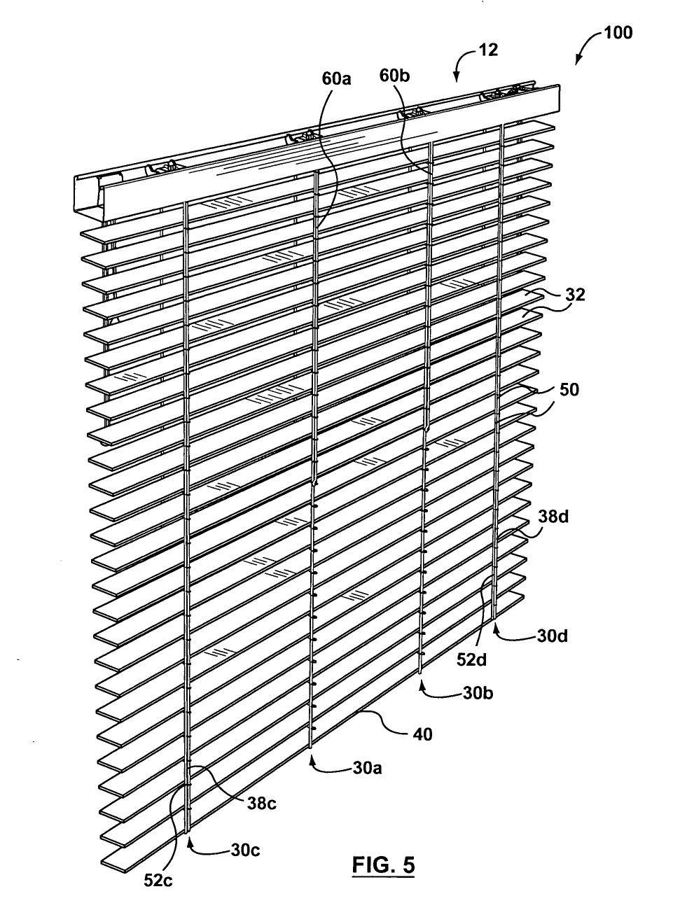

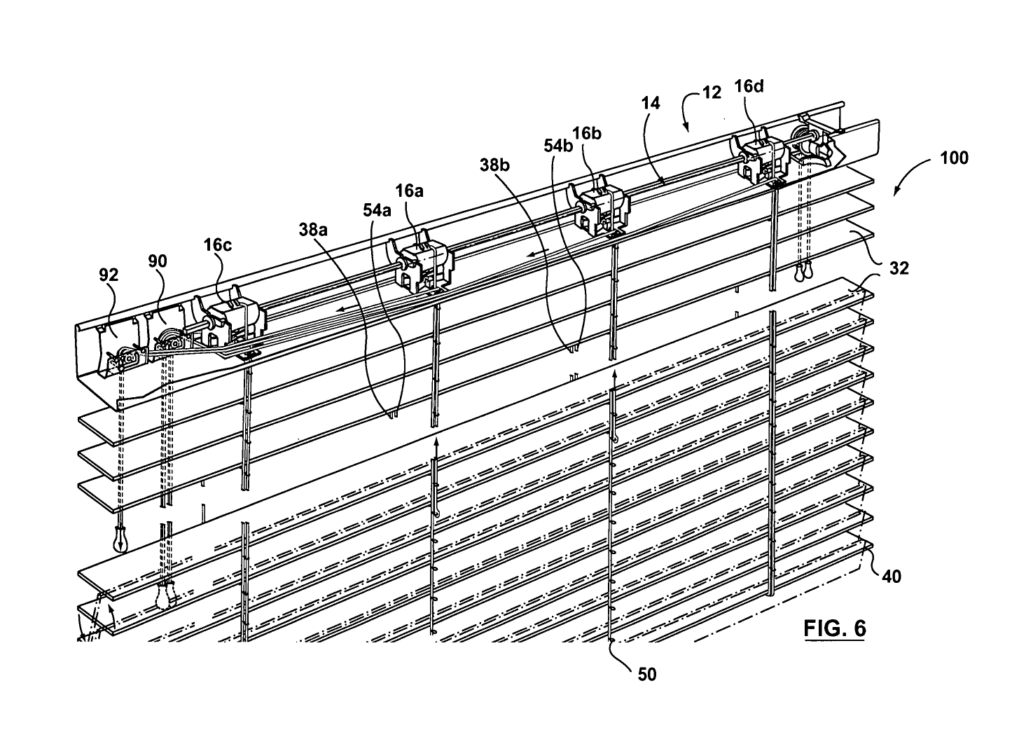

FIGS. 5 and 6 show a blind 100 according to a second embodiment of the present invention, which is particularly suitable for larger windows. In this embodiment, those parts which correspond to those in the first embodiment have been assigned like reference numbers and will not be further described.

Referring to FIGS. 5 and 6, four ladders 30a-d are provided for supporting the slats 32. Preferably, the ladders 30a-d are identical to those described for the first embodiment. The tilt mechanism 14 includes four cam members 16a-d from which the ladders 30a-d are suspended. Because, in this embodiment, the slats 32 have no slots, four lift cords 38a-d are provided which run along the front or rear cords of ladders (as described in detail below). The slats 32 may include notches (not shown) to engage the front and rear cords of the ladders 30a-d.

The lift cords 38a-d are secured to the bottom slat 40. Lift cords 38c and 38d pass through loops 50 on the rear cords 52c and 52d of ladders 30c and 30d. Lift cords 38a and 38b pass through loops 50 on the front cords 54a and 54b of ladders 30a and 30b.

Continuing to refer to FIGS. 5 and 6, adjustment cords 60a, 60b are connected to ladders 30a and 30b in the same manner as described in the first embodiment.

In this embodiment, two conventional cord locks 90, 92 are secured within the header rail 12. The first cord 90 lock locks and releases the lift cords 38a-d, and the second cord lock 92 locks and releases the adjustment cords 60a, 60b.

The operation of the first embodiment will now be described with reference to FIGS. 1, 2, 3A and 3B. The lifting and lowering of the entire blind 10 is controlled the lift cords 38a, 38b in a conventional manner and will not be further described. The tilting of the entire blind is controlled in a conventional manner by tilt cord 20 and will not be further described.

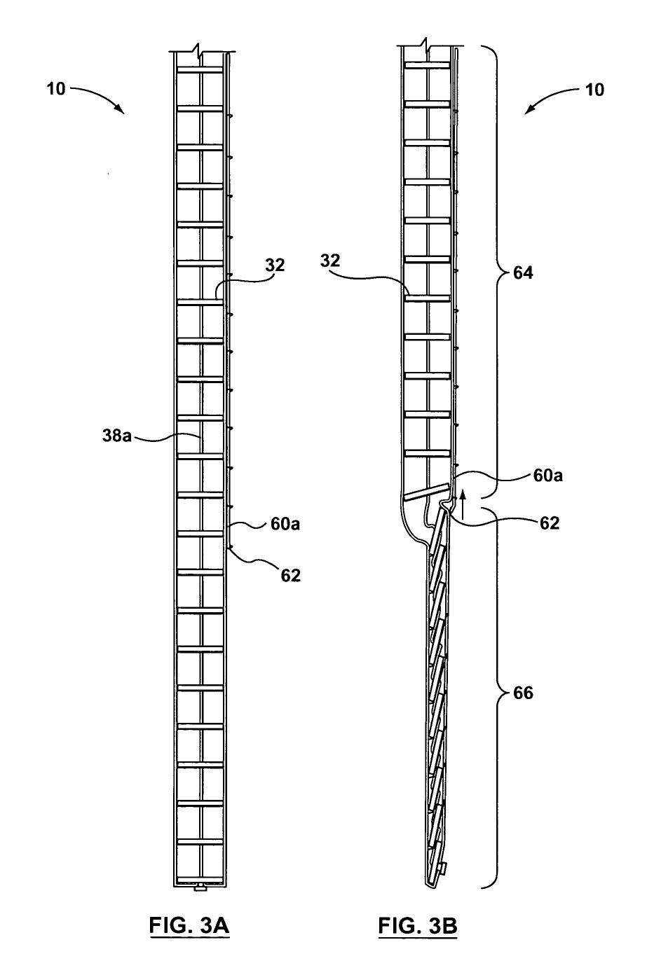

When the entire blind 10 is in a completely or partially open position (the completely open position is shown in FIG. 3A), the user may choose to control the tilt (i.e. open or close) only the lower tier 66 by pulling or releasing the adjustment cords 60a, 60b. The adjustment cords 60a, 60b pull on ladders 30a, 30b at the predetermined points 62 to tilt the slats 32 in the lower tier 66 into the closed position without moving the slats 32 of the upper tier 64 (as best shown in FIG. 3B). In addition, when the slats 32 of the blind 10 are in the closed position with the front edges of the slats pointing upward (not shown), the slats 32 of the lower tier 66 may be tilted between opened and closed positions by pulling and releasing the adjustment cords 60a, 60b, respectively.

The second embodiment is operated in the same manner as described above.

The venetian blind according to the present invention provides the advantage of manufacturing a multiple tier blind using standard off-the-shelf parts (i.e. standard cords and cord ladders) used for conventional single tier blinds, thereby reducing the cost and simplifying the manufacture of the multiple tier blind.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims.

1. A venetian blind comprising:
a) a header rail;
b) a first ladder and a spaced apart second ladder operatively suspended from the header rail;
c) a plurality of slats supported by the first and second ladders, the plurality of slats comprising a first tier and a second tier below the first tier, the second tier comprising a bottom slat;
d) a first lift cord adapted to raise and lower the plurality of slats, the first lift cord being connected to the bottom slat at one end thereof; and
e) a first adjustment cord connected to a predetermined point on the first ladder, wherein the first adjustment cord is adapted to tilt the slats of the second tier independently of the slats of the first tier by moving the first ladder at the predetermined point.

2. The venetian blind of claim 1, wherein the first and second ladders each comprise a front cord, a rear cord, and a plurality of rungs adapted to support the plurality of slats, wherein the first adjustment cord runs proximate to the front cord or the rear cord of the first ladder.

3. The venetian blind of claim 2, wherein the first ladder comprises a plurality of loops connected to at least a portion of the rear cord or the front cord thereof.

4. The venetian blind of claim 3, wherein the first adjustment cord runs through at least a portion of the plurality of loops proximate to the first tier and is secured to the first ladder at the predetermined point, wherein the predetermined point comprises a selected loop closest to an uppermost slat of the second tier.

5. The venetian blind of claim 4, wherein the second ladder comprises a plurality of loops connected to at least a portion of the rear cord or the front cord thereof.

6. The venetian blind of claim 4, comprising a second adjustment cord, wherein the second adjustment cord runs through at least a portion of the plurality of loops proximate to the first tier and is secured to the predetermined point of the second ladder.

7. The venetian blind of claim 6, wherein the first adjustment cord runs along the rear cord of the first ladder and the second adjustment cord runs along the rear cord of the second ladder, wherein the predetermined point of the first and second ladders is located on the rear cord.

8. The venetian blind of claim 6, wherein the header rail further comprises a tilt mechanism adapted to tilt the plurality of slats by moving the first and second ladders, wherein the first and second ladders are suspended from the tilt mechanism.

9. The venetian blind of claim 6, further comprising a cord lock operatively connected to the header rail, the cord lock being adapted to control the first lift cord and the first and second adjustment cords.

10. The venetian blind of claim. 6, further comprising a first cord lock connected to the header rail and a second cord lock connected to the header rail, wherein the first cord lock is adapted to control the first lift cord and the second cord lock is adapted to control the first and second adjustment cords.

11. The venetian blind of claim 6, wherein each of the plurality of slats defines a route hole, wherein the first lift cord passes through the route hole of each slat.

12. The venetian blind of claim 11, further comprising a second lift cord, wherein each of the plurality of slats defines a first and second spaced apart route holes, wherein the first lift cord passes through the first route hole of each slat and the second lift cord passes through the second route hole of each slat.

13. The venetian blind of claim 6, wherein the plurality of loops are located on the front and rear cords of the first and second ladders.

14. The venetian blind of claim 13, wherein the first lift cord and the first adjustment cord run through at least a portion of the plurality of loops on the rear cord of the first ladder.

15. The venetian blind of claim 14, comprising a second lift cord, wherein the second lift cord is connected to a bottom slat and runs through at least a portion of the plurality of loops on the front cord of the second ladder.

16. The venetian blind of claim 9, wherein the cord lock comprises:
a) a housing defining at least one pathway therein, the pathway comprising a first portion, a second portion and a third portion;
b) a retaining surface located in the housing;
c) a first member and a second member slidably received in the pathway; and
wherein the first member is movable between the first portion where the first lift cord moves freely and the second portion where the first member and the retaining surface cooperate to resist movement of the first lift cord;
wherein the second member is movable between the first portion where the adjustment cords move freely and the third portion where the adjustment cords and the retaining surface cooperate to resist movement of the adjustment cords.

17. The venetian blind of claim 16, wherein the cord lock further comprises a guide member adapted to guide the first lift cord between the retaining surface and the first member and guide the adjustment cords between the retaining surface and the second member.

18. The venetian blind of claim 17, wherein the first and second members each comprise a knurled rivet.

19. A cord lock for controlling a first cord and a second cord comprising:
a) a housing defining at least one pathway therein, the pathway comprising a first portion, a second portion and a third portion;
b) a retaining surface located in the housing; and
c) a first member and a second member slidably received in the pathway;
wherein the first member is movable between the first portion where the first cord moves freely and the second portion where the first member and the retaining surface cooperate to resist movement of the first cord;
wherein the second member is movable between the first portion where the second cord moves freely and the third portion where the first second and the retaining surface cooperate to resist movement of the second cord.

20. The cord lock of claim 19, further comprising a guide member adapted to guide the first cord between the retaining surface and the first member and the second cord between the retaining surface and the second member.

21. The cord lock of claim 20, wherein the first cord comprises at least one lift cord and the second cord comprises at least one adjustment cord, wherein the first and second members each comprise a knurled rivet.
